(19) United States
(12) Patent Application Publication
(10) Pub. No.: US 2026/0211418 A1
(43) Pub. Date: Jul. 23, 2026

(54) APPARATUS AND METHOD FOR DETERMINING A REPRESENTATION OF AN ENVIRONMENT

(71) Applicant: JAGUAR LAND ROVER LIMITED, Whitley, Coventry, Warwickshire (GB)

(72) Inventors: Jonathan LLOYD, Whitley, Coventry, Warwickshire (GB); Margaret TOOHEY, Whitley, Coventry, Warwickshire (GB); Stefan ARNAUTU, Whitley, Coventry, Warwickshire (GB); Jhonata QUEIROZ, Whitley, Coventry, Warwickshire (GB)

(21) Appl. No.: 19/140,253

(22) PCT Filed: Dec. 15, 2023
(86) PCT No.: PCT/EP2023/086050

§ 371 Date: Jun. 17, 2025

(30) Foreign Application Priority Data
Dec. 22, 2022 (GB) 2219504.4

(51) Int. Cl. G05D 1/246; G01S 17/931; G05D 107/13; G05D 109/10; G05D 111/10

(52) U.S. Cl. CPC G05D 1/2464; G01S 17/931; G05D 2107/13; G05D 2109/10; G05D 2111/17

(57) ABSTRACT

A vehicle control system receives, from a sensor, sensor data indicative of a location of one or more objects detected in an environment of the vehicle, and modifies an occupancy grid stored in a memory accessible to the control system in dependence on the sensor data, the occupancy grid representing an environment of the vehicle and having a plurality of cells, wherein each cell is associated with at least one value indicative of a likelihood of a corresponding portion of the environment being occupied by one of the one or more objects. The modifying includes determining one or more cells where a field of view of the sensor is obstructed by at least one of the one or more objects; and modifying the at least one value associated with the determined one or more cells to be indicative of an increased uncertainty of the cell being occupied by an object.

### TECHNICAL FIELD

The present disclosure relates to determining an occupancy grid representing an environment. Aspects of the invention relate to a control system, to a system, to a vehicle, to a method and to computer software.

### BACKGROUND

It is necessary for a robot to determine information about its environment, such as information about objects in the environment. Where the robot is capable of autonomous movement, such as an autonomous vehicle or vehicle having an at least partly autonomous capability, the information about objects is used for navigation to avoid the objects. It is known for an occupancy grid to be used to store information about the environment, such as a location of objects in the environment. The occupancy grid represents the environment of the robot and has a plurality of cells, each representing a portion of the environment and storing an indication of a probability of the occupancy of the respective portion. Sensors associated with the robot, such as the vehicle, provide measurement data indicative of the location of objects and the measurement data is used to update the occupancy grid. In this way, the occupancy grid can be used to track dynamic objects in the environment.

Often the sensors associated with the robot are high definition which provide dense measurement data relating to the environment, such as dense point cloud data indicative of objects. An example of such a high-definition sensor is a 64 laser LIDAR sensor. Because of this high density, an absence of objects e.g. empty space can also be reliably inferred. However such high-definition or high-density sensors have an associated cost and complexity. It is desired to utilise lower definition or density sensors to update an occupancy grid.

It is an aim of the present invention to address one or more of the disadvantages associated with the prior art.

### SUMMARY OF THE INVENTION

Aspects and embodiments of the invention provide a control system, a system, a vehicle, a method and computer software.as claimed in the appended claims.

According to an aspect of the present invention there is provided a control system for a vehicle, the control system comprising at least one controller, the control system being configured to receive, from at least one sensor, sensor data indicative of a location of one or more objects detected in an environment of the vehicle, modify an occupancy grid stored in a memory accessible to the control system in dependence on the sensor data, wherein the modifying comprises the control system being configured to determine one or more cells of the occupancy grid within a field of view of the sensor for which the sensor data did not indicate the location of an object. Advantageously knowledge that the cells are within the field of view of the sensor means that, should an object exist, it would likely have been detected. The control system may modify a value associated with the determined one or more cells of the occupancy grid for which the sensor data did not indicate the location of an object.

According to an aspect of the present invention there is provided a control system for a vehicle, the control system comprising at least one controller, the control system being configured to receive, from at least one sensor, sensor data indicative of a location of one or more objects detected in an environment of the vehicle, modify an occupancy grid stored in a memory accessible to the control system in dependence on the sensor data, wherein the modifying comprises the control system being configured to determine one or more cells of the occupancy grid within a field of view of the sensor for which the sensor data did not indicate the location of an object, and modify a value associated with the determined one or more cells of the occupancy grid to be indicative of an increased uncertainty associated with the determined one or more cells being occupied. Advantageously, the occupancy grid is indicative of cells, corresponding to locations in the environment, for which the uncertainty of occupancy is increased due to the portions of the environment being obscured.

According to an aspect of the present invention there is provided a control system for a robot, the control system comprising at least one controller, the control system being configured to receive, from at least one sensor, sensor data indicative of a location of one or more objects detected in an environment of the vehicle, and to determine one or more cells of the occupancy grid where the field of view of the sensor is obstructed by at least one of the one or more objects; and modify at least one value associated with the determined one or more cells of the occupancy grid to be indicative of an increased uncertainty of the cell being occupied by an object. Advantageously, the occupancy grid is indicative of cells, corresponding to locations in the environment, for which the uncertainty of occupancy is increased due to the portions of the environment being obscured.

According to an aspect of the present invention there is provided a control system for a vehicle, the control system comprising at least one controller, the control system being configured to receive, from at least one sensor, sensor data indicative of a location of one or more objects detected in an environment of the vehicle, modify an occupancy grid stored in a memory accessible to the control system in dependence on the sensor data, the occupancy grid representing an environment of the vehicle and having a plurality of cells, wherein each cell is associated with at least one value indicative of a likelihood of a corresponding portion of the environment being occupied by one of the one or more objects, wherein the modifying comprises the control system being configured to determine one or more cells of the occupancy grid within a field of view of the sensor for which the sensor data did not indicate the location of an object; and modify the at least one value associated with the determined one or more cells of the occupancy grid to be indicative of an increased likelihood of the cell being unoccupied by an object. Advantageously, the occupancy grid is indicative of cells, corresponding to locations in the environment, for which the likelihood of the cell being unoccupied is increased due to the portions of the environment being within the field of view of the sensor, but the sensor data not indicating the location of an object.

According to an aspect of the present invention there is provided a control system for a vehicle, the control system comprising at least one controller, the control system being configured to receive, from at least one sensor, sensor data indicative of a location of one or more objects detected in an environment of the vehicle, modify an occupancy grid stored in a memory accessible to the control system in dependence on the sensor data, the occupancy grid representing an environment of the vehicle and having a plurality of cells, wherein each cell is associated with at least one value indicative of a likelihood of a corresponding portion of the environment being occupied by one of the one or more objects, wherein the modifying comprises the control system being configured to determine one or more cells of the occupancy grid within a field of view of the sensor for which the sensor data did not indicate the location of an object and modify the at least one value associated with the determined one or more cells of the occupancy grid to be indicative of an increased likelihood of the cell being unoccupied by an object. Advantageously, the occupancy grid is indicative of cells, corresponding to locations in the environment, for which the likelihood of the cell being unoccupied is increased due to the portions of the environment being within the field of view of the sensor, but the sensor data not indicating the location of an object.

The one or more cells of the occupancy grid within a field of view of the sensor for which the sensor data did not indicate the location of an object may be assumed as empty cells. Advantageously, the cells are assumed as empty due to the sensor data not indicating the location of the object corresponding to the cell.

The modifying optionally comprises the control system being configured to determine one or more cells of the occupancy grid where the field of view of the sensor is obstructed by at least one of the one or more objects, and modify the at least one value associated with the determined one or more cells of the occupancy grid to be indicative of an increased uncertainty of the cell being occupied by an object. Advantageously, modification of the at least one value is made due to the portions of the environment being obscured from the sensor.

The at least one of the one or more objects may have a location corresponding to at least one other cell of the occupancy grid. Advantageously the location of the object is associated with the at least one other cell of the occupancy grid. The one or more cells of the occupancy grid where the field of view of the sensor is obstructed may be obstructed cells.

Advantageously the obstructed cells are recognised to be cells within the field of view, but which the sensor cannot determine the location of an object. The one or more cells of the occupancy grid where the field of view of the sensor is obstructed by at least one of the one or more objects are cells determined as being in a shadow of the one of the one or more objects detected in the environment of the vehicle. Advantageously, shadowed cells may not be observed by the sensor.

The modifying optionally comprises the control system combining a predetermined free mass value with a prior free mass for the one or more cells of the occupancy grid within the field of view of the sensor for which the sensor data did not indicate the location of an object. Advantageously the combining introduces the updated value to the prior free mass.

The predetermined free mass value may be equal to or greater than 0.7. The free mass value may be equal to or greater than 0.9. Advantageously the free mass value may be a value which promotes the cell as being indicative of not being occupied i.e. having a relatively higher free mass.

The modifying may comprise the control system combining a predetermined unknown mass value with a prior unknown mass for the one or more cells of the occupancy grid within the field of view of the sensor for which the sensor data did not indicate the location of an object. Advantageously the unknown mass value may be indicative of the occupancy of the cell being unknown.

The predetermined unknown mass value may be equal to or greater than 0.4. The unknown mass value may be around 0.5. Advantageously the unknown mass value may be indicative of the occupancy of the cell being unknown.

Optionally, setting the unknown mass comprises setting a free mass value and an occupied mass value associated with each cell to corresponding values such that the free mass is equal to or greater than the predetermined value. The unknown mass value may correspond to a difference between a free mass value and an occupied mass value associated with each cell. Advantageously the free mass and the occupied mass values may be controlled.

The combining is optionally according to a Dempster Shafer rule of combination. Advantageously the Dempster Shafer rule of combination allows combination of the predetermined value and the prior value.

The modifying may comprise the control system being configured to determine the field of view of the sensor in dependence on one or more characteristics associated with the sensor, and select cells of the occupancy grid corresponding to the field of view of the sensor. Advantageously the field of view is determined in dependence on the characteristics to resemble the actual field of view of the sensor.

The modifying optionally comprises the control system being configured to determine a first field of view of the sensor, determine one or more cells of the occupancy grid within the first field of view of the sensor for which the sensor data did not indicate the location of an object, determine a first cell of the occupancy grid corresponding to a location of one of the one or more objects detected in the environment of the vehicle within the first field of view of the sensor, and determine a second field of view of the sensor in dependence on one or more characteristics associated with the sensor and the location of the one of the one or more objects. Advantageously the field of view of each respective sensor is determined.

The control system is optionally configured to determine the one or more cells of the occupancy grid where the field of view of the sensor is obstructed by at least one of the one or more objects as cells in a shadow of the one of the one or more objects detected in the environment of the vehicle. Advantageously the field of view does not extend to areas in the shadow and therefore the sensor cannot accurately determined the occupancy of such cells.

The control system may be configured to sequentially select cells of the occupancy grid outward from a location of the sensor to determine whether the sensor data indicates the location of an object. Advantageously the outward processing of cells allows efficient modification of cell values.

According to a further aspect of the present invention there is provided a system for a vehicle, comprising the control system of any preceding claim, and at least one sensor arranged to output sensor data indicative of a location of one or more objects detected in an environment of the vehicle.

The at least one sensor may comprise one or more of a radar sensor, a lidar sensor, and/or an optical sensor.

According to an aspect of the present invention there is provided a vehicle comprising a control system as described above or a system as described above.

According to an still further aspect of the present invention there is provided a computer-implemented method, comprising receiving, from at least one sensor, sensor data indicative of a location of one or more objects detected in an environment of a vehicle, modifying an occupancy grid stored in a memory in dependence on the sensor data, the occupancy grid representing an environment of the vehicle and having a plurality of cells, wherein each cell is associated with at least one value indicative of a likelihood of a corresponding portion of the environment being occupied by one of the one or more objects, wherein the modifying comprises determining one or more cells of the occupancy grid within a field of view of the sensor for which the sensor data did not indicate the location of an object, and modifying the at least one value associated with the determined one or more cells of the occupancy grid to be indicative of an increased likelihood of the cell being unoccupied by an object.

The at least one value associated with the determined one or more cells of the occupancy grid may be an unknown mass value. The method may comprise modifying the unknown mass value to a value indicative of the uncertainty of the cell being occupied by the object. The unknown mass value may be given a value of between 0.4 and 0.6.

The at least one value associated with the determined one or more cells of the occupancy grid may be a free mass value and an occupied mass value. The method may comprise modifying the free mass value and the occupied mass value to respective values indicative of the uncertainty of the cell being occupied by the object.

The modifying optionally comprises: determining one or more cells of the occupancy grid within the field of view of the sensor for which the sensor data did not indicate the location of an object; and modifying the at least one value associated with the determined one or more cells of the occupancy grid to be indicative of an increased likelihood of the cell being unoccupied by an object.

The modifying optionally comprises determining one or more cells of the occupancy grid where the field of view of the sensor is obstructed by at least one of the one or more objects, and modifying the at least one value associated with the determined one or more cells of the occupancy grid to be indicative of an increased uncertainty of the cell being occupied by an object.

The modifying optionally comprises combining a predetermined free mass value with a prior free mass for the one or more cells of the occupancy grid within the field of view of the sensor for which the sensor data did not indicate the location of an object.

The predetermined free mass value may be equal to or greater than 0.7.

The modifying may comprise combining a predetermined unknown mass value with a prior unknown mass for the one or more cells of the occupancy grid within the field of view of the sensor for which the sensor data did not indicate the location of an object.

The combining may be according to a Dempster Shafer rule of combination.

The modifying optionally comprises determining the field of view of the sensor in dependence on one or more characteristics associated with the sensor, and selecting the one or more cells of the occupancy grid corresponding to the field of view of the sensor.

The modifying optionally comprises determining a first field of view of the sensor, determining one or more cells of the occupancy grid within the first field of view of the sensor for which the sensor data did not indicate the location of an object, determining a first cell of the occupancy grid corresponding to a location of one of the one or more objects detected in the environment of the vehicle within the first field of view of the sensor, and determining a second field of view of the sensor in dependence on one or more characteristics associated with the sensor and the location of the one of the one or more objects.

According to yet another aspect of the present invention there is provided a Computer software which, when executed by a computer, is arranged to perform a method as described above. A computer readable data storage medium may have tangibly stored thereon the computer software.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a system according to an embodiment of the present invention;

FIG. 2 shows a vehicle according to an embodiment of the present invention;

FIG. 3 shows an illustration of an occupancy grid according to an embodiment of the present invention;

FIG. 4 shows a method according to an embodiment of the present invention;

FIG. 5 shows a method according to another embodiment of the present invention;

FIG. 6 shows an illustration of an occupancy grid according to another embodiment of the present invention; and

FIG. 7 shows probabilities according to an embodiment of the invention.

### DETAILED DESCRIPTION

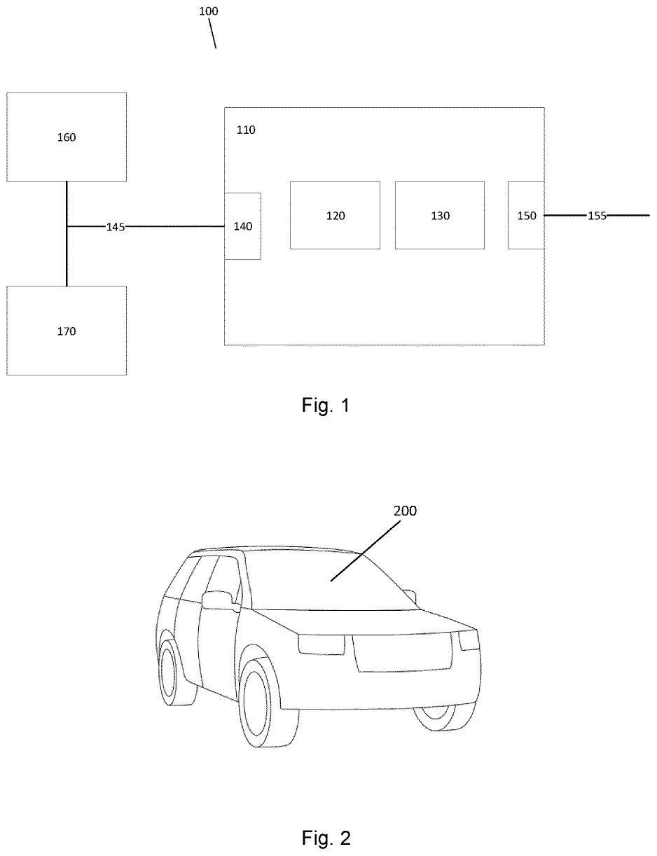

With reference to FIG. 1, there is illustrated a system 100 according to an embodiment of the invention. The system 100 is for use with a robot such as a vehicle 200 according to an embodiment of the invention as shown in FIG. 2. The vehicle 200 is an example of a robot with an autonomous movement or navigation capability to navigate around an environment in which the vehicle 200 is located. For example, the vehicle 200 may have Level 4 or 5 autonomy capability as defined by SAE International. The vehicle 200 may comprise the system 100 as part of providing such capability. Whilst embodiments of the invention are described with respect to such a vehicle 200 it will be appreciated that embodiments of the invention are not limited in this respect.

The system 100 is arranged to determine an occupancy grid 300 relating to an environment of the vehicle 200. The occupancy grid 300 represents the environment of the vehicle 200 and has a plurality of cells, each representing a portion of the environment and being associated with a probability indicative of the occupancy of the respective portion corresponding to the cell. The occupancy grid is useful for navigating the vehicle 200 within the environment, such as for tracking movement of one or more objects in the environment as will be appreciated.

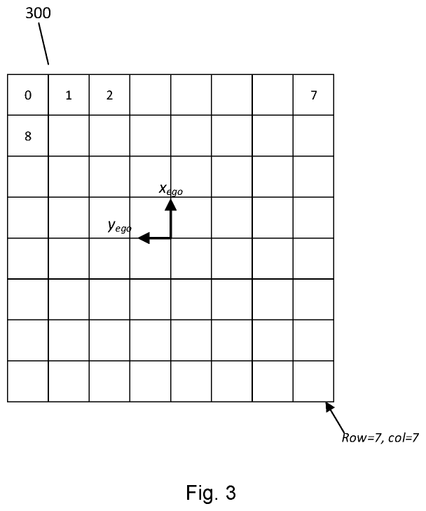

A representation of example occupancy grid or occupancy grid map 300 is illustrated in FIG. 3. The occupancy grid map 300 and the cells forming part thereof are defined by parameters which define their sizes such that the size and resolution of the occupancy grid map 300 may be chose for each particular use case. In the example of FIG. 3 the occupancy grid map 300 is 8×8 in size and is thus formed by 64 cells. The occupancy grid map 300 is selected to have a cell size of 1 m×1 m and thus the example square occupancy grid map 300 has sides of length 8 m and represents a 64 m² area of the environment. It will be appreciated that the illustrated occupancy grid map 300 is relatively small for practical application and larger occupancy grid maps are typically used, such as for example, a 120 m×120 m occupancy grid map although embodiments of the invention are not limited in this respect. The occupancy grid map 300 is formed by rows and columns of cells which may each have a corresponding number. In some embodiments cells each have a linear cell index as illustrated which may begin at 0 for a cell in one corner, such as the top-left corner of the occupancy grip map 300 as illustrated. In some embodiments, the vehicle 200 is assumed to be located at a centre of the occupancy grid 300 as indicated by arrows shown. In such embodiments, a relative coordinate space system may be used wherein cells forward of the vehicle are assigned a positive x coordinate value and cells to a left lateral side of the vehicle being associated a positive y coordinate value. Such a coordinate space may be referred to as an EGO relative coordinate space.

The system illustrated in FIG. 1 according to an embodiment of the invention is arranged to output data indicative of the occupancy grip map 300 for use in navigating the vehicle 200. The occupancy grip map 300 is determined in dependence on sensor measurement data indicative of the environment of the vehicle 200 which is provided by one or more sensors associated with the vehicle 200 as will be explained. At least some of the one or more sensors may provide sensor measurement data indicative of a detection of an object whose location corresponds to one or more cells (an object can be determined to correspond to more than one cell) in the occupancy grip map 300. In embodiments of the invention, a field of view (FOV) of at least one of the sensors is determined and, for any cells within the FOV of the sensor for which the sensor measurement data did not indicate the location of an object, data associated with the cell is updated or modified to be indicative of an increased likelihood of the cell being unoccupied by an object. This allows a robust occupancy grip map 300 to be determined even when the sensor measurement data is sparse or low resolution. The use of the FOV of the sensor in determining the occupancy grid map 300 aims to ensure that free space is asserted for portions of the environment within visibility of the sensor.

The system 100 shown in FIG. 1 comprises one or more controller 110. In the illustrated example, the system 100 comprises one controller 110 although it will be appreciated that embodiments of the invention are not limited in this respect. The controller 110 is arranged to, in use, output data 155 indicative of the occupancy grip map 300.

Each controller 110 may comprise a respective processing means 120, such as an electronic processing device 120 or computer processor, hereinafter processor 120. The processor 120 is arranged to operably execute computer-readable instructions which may be stored in a memory means 130 formed by one or more memory devices 130 forming a memory 130 which is communicatively coupled to the processing device 120. The controller 120 comprises an input means 140 and an output means 150. The input means 140 may comprise an electrical input 140 of the controller 110 The output means 150 may comprise an electrical output 150 of the controller 110. In some embodiments, the input means 140 and output means 150 may be unified such as in the form of a network interface which inputs and outputs data, for example to a communication bus of the vehicle 200. The controller 110 may therefore receive data from the communication bus and output data onto the communication bus. In some embodiments, the input means 140 is arranged to receive sensor measurement data 145 from one or more sensors 160, 170 associated with the vehicle 200. In the example, the system 100 comprises first 160 and second 170 sensors although it will be appreciated that this merely an example. At least some of the sensors 160, 170 may emit radiation, such as from a laser, and receive radiation reflected from an object, such as via a photodiode or similar. The reflected radiation is used to determine a point corresponding to the object wherein a collection of points each corresponding to reflections of radiation form a point cloud. Data indicative of detections of objects is provided to the controller 110 as the sensor measurement data 145.

The processor 120 is arranged to store in the memory 130 data indicative of the occupancy grip map 300. The processor 120 is arranged to update or modify the occupancy grip map 300 based on the incoming sensor measurement data 145. Fusing of incoming sensor measurement data with the occupancy grid may be performed by a dynamic occupancy grid map (DOGMa) process. The DOGMa process 300 may be performed at a periodic time interval based on received sensor measurement data 145. A time interval variable may be used to represent the time between iterations or cycles of a DOGMa process as explained below in connection with block 410. The DOGMa process provides a method of fusing sensor data in the dynamic occupancy grid map. The DOGMa process is explained more in a PHD Thesis by D. Nuss, “A Random Finite Set Approach for Dynamic Occupancy Grid Maps”, 2018 also published in The International Journal of Robotics Research, which are herein incorporated by reference.

Embodiments of the present invention are described connection with the DOGMa process. However it will be understood that other processes, such as using a direct association of cells to track level fusion or Bayesian Occupancy filters, may be used for updating or modifying an occupancy grid and the usefulness of embodiments of the present invention are not limited to the DOGMa process. Embodiments of the present invention operate to influence values associated with at least some cells of the occupancy grid in dependence on a field of view of a sensor providing sensor data. In particular, embodiments of the present invention influence a probability associated with at least some cells of being free, as will be explained. In some embodiments, values associated with at least some cells of the occupancy grid are influenced to be indicative of an uncertainty associated with a state of the cell when those cells are obstructed from the field of view of the sensor. In this way, not only are values associated with cells whose location corresponds to detected objects updated, but also values associated with cells assumed to free or empty and the obstructed cells. Advantageously this improves the updating or modifying of the occupancy grid and may allow, for example, use of sensors with lower resolution thereby enabling a reduction in cost, for example.

In some embodiments, a particle filter is used to model a state of the occupancy grid map 300. The particle filter maintains a list of particle states, one or more weights and cell indices and indices of cells of the occupancy grid map 300 to which the particles belong. A label may be assigned to each particle as an identifier for an object (if any) to which the particle belongs. A next state of the particles is predicted and are updated by detections of objects in the sensor measurement data 145 as will be explained.

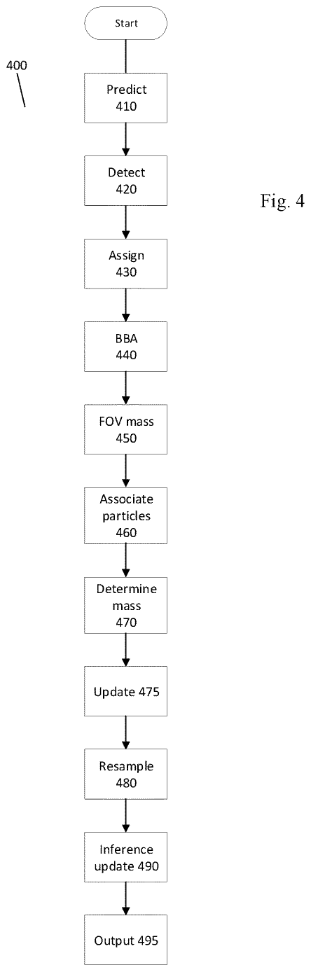

A method 400 according to an embodiment of the present invention is explained with reference to FIG. 4. The method 400 may be performed by the processor 120 and instructions representing the method may be stored in the memory 130 as computer readable instructions.

In block 410 a prediction operation is performed. The prediction operation predicts a new location for particles and updates the cells of the occupancy grip map 300 with which the particles are associated accordingly.

In some embodiments, for the purpose of the prediction operation in block 410, a Transition Matrix is created using a time_step variable indicative of the periodic time interval between cycles of the method 400 updating or modifying the occupancy grid map 300. A noise generation function may be used to create a process_noise matrix that is used to model uncertainty in the particle predictions. This may be performed by using a randomly generated matrix with a configurable i.e. selected standard deviation.

In the particle prediction of block 410, the state of the particles used in the DOGMa process are predicted. The state may be represented with position and velocity, such as: x,y, vx, vy. For reasons of computational complexity, in some embodiments a two dimensional world is used in which the z axis is not modelled. The state prediction may be performed by matrix multiplication between the current state and the transition matrix. In some embodiments, the process_noise matrix is added to the result of the multiplication to introduce uncertainty. Some particles close to the edge of the occupancy grip map 300 grid will be predicted to leave the bounds of the occupancy grid map 300 when their velocity takes them over the boundary at the next time step. These particles are removed from the DOGMa process.

The weight of each particle may be degraded whenever a prediction is carried out in block [symbol] may be performed by a multiplication of a weights matrix and a persistence_probability variable. The weights matrix is a matrix which may be used in some embodiments to store a weight associated with each particle. The weights matrix may be a 1×N matrix or vector, where N is the number of particles. The persistence_probability is a parameter that controls the longevity of particles in the DOGMa process. The persistence_probability may have a value of between 0.0-1.0, wherein 0.0 means the particle will not persist and 1.0 meaning the particle weight will never degrade. Thus a value between 0 and 1 is usually chosen. As a result of the prediction operation in block 410 each particle has an updated location and velocity. As the particles have moved, the cell index to which they are each assigned is updated. The updating of cell indexes may be performed by mapping the x,y state indicative of the location of each particle to the location of the cell of the occupancy grid map 300 to which it belongs.

Cell occupancy may use Basic Belief Assignment (BBA) from Dempster-Schafer Theory, as will be appreciated by the skilled person. At a basic level for the DOGMa process, this means that a variable predicted_occupancy_mass may be maintained, that represents the likelihood that a cell of the occupancy grid map 300 is occupied, and predicted_free_mass, that represents the likelihood that cell of the occupancy grid map 300 is unoccupied or free. Here these masses may be determined in block 410 for each cell of the occupancy grip map 300 using the weights of particles, such as stored in the weights matrix, assigned to each respective cell. This BBA is then stored as a prior mass or prior BBA, which is used subsequently to determine a posterior calculated mass or posterior BBA, as will be explained. In other words, the prior BBA is prior to receiving measurements and the posterior BBA is as updated during an iteration of the method 400.

In block 420 any objects in the environment of the vehicle 200 are detected by the one or more sensors 160, 170 associated with the vehicle 200. Each sensor 160, 170 outputs sensor measurement data 145 indicative of any detected objects, where the sensor measurement data 145 is received by the controller 110. In some embodiments, the sensor measurement data 145 is formed into a measurement grid map as discussed below. In some embodiments the measurement grid map is another grid map which may match the dimensions of the DOGMa occupancy grid map 300 i.e. in the example the measurement grid map 300 may be 8×8 cells as in FIG. 3, although it will be appreciated that other sizes of measurement grip map may be used.

In block 430 the detections of any objects indicated in the sensor measurement data 145 received in block 420 are mapped onto the measurement grid map in bock 420 and assigned to cells of the measurement grid map. As discussed above, at least from some sensors 160, 170, the detections of objects in the sensor measurement data 145 are provided as a point cloud. The point cloud comprises point data indicative of locations at which an object is detected by the sensors 160, 170. The points in the point cloud have associated x,y,z positions. The occupancy grip map 300 may be, especially for a land-going robot or vehicle, 2D i.e. lacking in dimension z. Therefore, the points in the point cloud may be flattened.

As part of the flattening, points with z axis values that are outside of a region-of-interest associated with the vehicle may be removed e.g. a point detected 20 meters above the EGO vehicle does not form part of the measurement grid map 300. The flattened points are then mapped or assigned to cells of the measurement grip map in block 430.

In block [symbol] occupancy probability is determined for the cells of the measurement grid map. Each cell of the measurement grid map is associated with one or both of an occupied mass and a free mass. In some embodiments, each cell of the measurement grid map, and also the occupancy grid map, is associated with a value indicative of an occupied mass and a value indicative of a free mass of the respective cell. The occupied mass is a probability or belief of the cell being occupied by an object and the free mass is a probability of the cell being free or unoccupied. Based on these mass values, a value indicative of an unknown mass or probability may be determined as a difference between the two mass values.

In some embodiments, a detection of an object in a cell raises the occupied mass of one or more adjacent cells. In some embodiments, a 2D Gaussian Kernel is created which allows the detection in one cell of the measurement grid map to raise the occupied mass of adjacent cells. The Gaussian Kernel generates a matrix where the values inside the cells of the matrix correspond to a Gaussian distribution with mean 0 and standard deviation given by a sigma parameter. The occupied mass of each cell of the measurement grid map may be initialised to all be zero, then a list of cells that contain detections from block 420 is used to generate beliefs for each cell to be occupied. In some embodiments, the beliefs may be generated by using matrix convolution of the Gaussian Kernel applied to the measurement grid map. A vector of occupied mass is produced which is used to generate the cell occupancy BBA as described above with respect to the occupancy grid map. The Dempster-Schafer Rule of Combination may be used where cell mass is updated or modified multiple times, for example when a cell is adjacent to two detections, or when multiple detections are in one cell. As a result of block 440, in some embodiments each cell of the measurement grid is associated with a variable occupancy_mass which represents the likelihood that the respective cell of the measurement grid map 300 is occupied, and free_mass which represents the likelihood of the respective cell being empty or free. In other embodiments, each cell may be associated with a data structure such as occupancy_bba which contains values corresponding to the occupancy_mass and the free_mass.

In block 450 a field-of-view BBA is determined which is combined with the BBA of the measurement grid map determined in block 440. In block 450, for each of at least one of the one or more sensors 160, 170, the FOV of the sensor is used to influence the mass of cells. In particular, in some embodiments, cells within the FOV of the sensor 160, 170 in which an object has not been detected i.e. are absent a detected object, the mass of the cell is determined to be indicative of being free. In some embodiments, cells which are within the FOV but are obscured from the sensor 160, 170 by an object are determined to have a mass indicative of unknown occupancy, since the occupancy of the cell cannot be determined since isn't visible to the sensor 160, 170, as will be explained

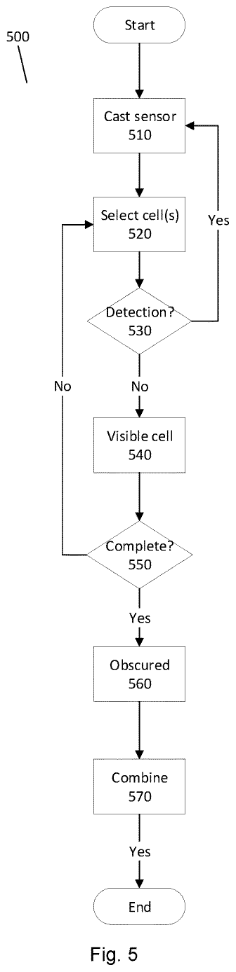

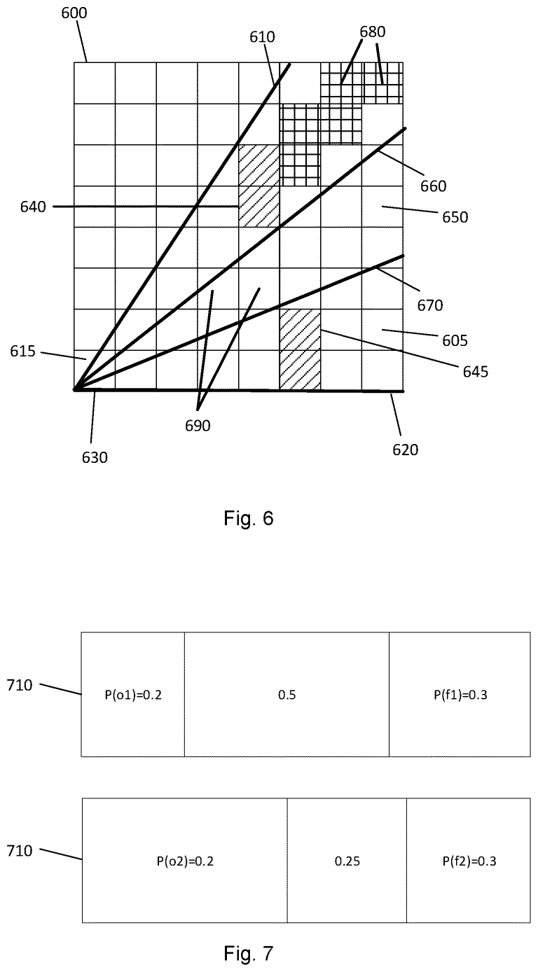

A method 500 according to an embodiment of the invention of applying the FOV of a sensor 160, 170 to the measurement grid map is illustrated in FIG. 5. The method 500 may be performed in block 450. The method 500 will be explained with reference to FIG. 6 which illustrates a portion of an example measurement grid map 600. The measurement grid map 600 is illustrated in relation to a sensor 160, 170 associated with a vehicle being located at the origin 0, 0 (bottom left-hand corner). Therefore the portion of the map illustrated in FIG. 6 is located upper-right of the vehicle 200. The measurement grid map 600 illustrates cells corresponding to detections of objects with diagonal shading such as cell 640.

As noted above, the method 500 is described connection with the DOGMa process of [symbol] with it being understood that its usefulness is not limited to the DOGMa process.

Referring to FIG. 5, the method 500 comprises a block of 510 of determining cells of the measurement grid within the FOV of the sensor. In the described example, the FOV of the sensor is described as being a cone. It will be appreciated that in other examples the FOV of the sensor 160, 170 may have another shape, such as being circular, oval or rectangular as examples. FIG. 6 illustrates the FOV of the sensor 160, 170 as a cone 605 extending between first and second boundary lines 610, 620 at each peripheral sides of the cone 605 extending from the origin (0,0) at which the sensor 160, 170 is located. The FOV 605 of the sensor 160, 170 may be referred to as a first FOV 605.

The FOV, in this embodiment the cone, 605 is generated for each sensor 160, 170 using its extrinsics or characteristics, such as one or more of its location about the vehicle, angular resolution and range. The cone 605 represents an area in which we have an increased confidence of it being empty, except where detections of objects exist and the occluded space behind detections as will be explained. For every sensor 160, 170 the FoV method 500 determines a FOV, such as the cone 605 in the example, originating from the sensor's 160, 170 position relative to EGO vehicle centre point which may be the rear axle in some embodiments.

In some embodiments of the method 500, the environment around the EGO vehicle is divided into a plurality of areas or sectors. In one embodiment, the environment is divided into octants, although it will be realised that other numbers of sectors may be used. The method 500 may then be performed separately for each sector, which advantageously reduces computation complexity. In some embodiments, the method may be performed at least partly in parallel for two or more sectors which reduces a computation time. The FOVs of each sensor 160, 170, such as cones 605 cast by the sensors, can cross into multiple octants i.e. the FOV of a sensor is not necessarily confined to one sector. In FIG. 6, the cone 605 is cast in block 510 on the measurement grid map 600 which is already divided into cells of a uniform size.

In block 520 one or more cells of the measurement grid map 600 are selected which are at least partially within the FOV 605 of the sensor i.e. within the cone 605 in the illustrated embodiment. A cell may be selected if it is only partially within the FOV 605 of the sensor. In some embodiments, the method 500 iterates over columns of the measurement grid map 600 moving away from the origin (0,0) of the cone 605 until it reaches the bounds of the cone, based on the respective sensor's angular resolution and the range of the sensor 160, 170. In the example, the sensor's 160, 170 range is considered to extend to the periphery of the measurement grid map 600 but it will be appreciated that the range may fall within the measurement grid map 600 i.e. it may not reach the edge of the map 600. For example, a first column 630 is selected in block 520 and one or more cells within that column are selected which are at least partially between the boundaries 610, 620. The first column is that with a lowest column index in an embodiment.

In block 530 it is determined if the selected cell(s) contain a detection of an object and, if not, the method 500 moves to block 540.

In [symbol] which are at least partially within the FOV 605 of the sensor 160, [symbol] and which are not occupied by an object, these cells are marked as visible to the sensor 160, 170 and empty or free i.e. not occupied. Advantageously, since only cells within the FOV 605 of the sensor 160, 170 are marked in this way, this ensures that only cells where an object would expected to have been detected (being within the FOV 605 of the sensor 160, 170), but in which no object has actually been detected, such as cell 615, are marked. Thus for cell 615 the sensor data did not indicate the location of an object in said cell 615 with the cell being within the FOV 605. Thus, when other cells within the FOV 605 have corresponding sensor data indicating the detection of an object and thereby demonstrating that the sensor 160, 170 is operational, it can be better assumed that the cell 615 is actually empty as no object is detected within the cell 615.

If, in block 530, one of the selected cells, i.e. within the current column, contains a detection of an object, the method 500 is recursive in that it returns to block 510 where a new FOV is cast for the sensor 160, 170. In a second iteration of block 510, the method 500 creates a new FOV between the detected one or more objects and/or a boundary of the previous FOV. For example, a cell 640 comprising an object detection is determined in block 530 causing the method to return to block 510. In block 510 a second FOV 650 is cast comprising boundaries 660, 670 between cells comprising detections of objects, i.e. cells 640, 645 or a boundary of the current sector or octant, as shown in FIG. 6. The method 500 then repeats for the newly cast FOV 650 of the sensor. The newly cast FOV 650 represents a region into which the sensor 160, 170 has visibility between detected object(s).

In block 550, after marking cell(s) as visible and empty in block 540, it is considered whether all cells within the current FOV 605, 650 of the sensor 160, 170 which are visible to the sensor have been considered. If not, the method returns to block 520 to select one or more further cell(s), such as within a next column of the measurement grid map 600. If, however, all visible cells have been considered the method moves to block 560.

In block 560 remaining cells within the FOV 605, 650 of the sensor 160, 170 which are not visible and empty or corresponding to a detected object 640, 645 are marked as not visible to the sensor 160, 170, or obscured to the sensor 160, 170, such as cells 680. For these cells 680, the sensor 160, 170 is not able to determine whether the cells correspond to a location of an object due to being obscured from the sensor's FOV by an object 640. Thus, the occupancy of these obscured cells 680 is unknown or indeterminate by the sensor.

As a result of the method 500, cells in the measurement grid map 600 which are not occupied by detected objects are marked or identified as being visible and empty, such as cells 690, or obscured, such as cells 680. It can be considered that rays of illumination are cast outward from the sensor 160, 170 to illuminate regions within the FOV 605, 650 of the sensor 160, 170. Illuminated cells of the measurement grid map 600 which are not occupied are considered as being empty 690, whereas cells 680 within a shadow of an object 640 caused by the illumination are considered as being indeterminate in occupancy.

For cells in block 540 determined as being visible and empty 690, a free mass for those cells is set to a predetermined value. The predetermined value is indicative of a probability of being free, such as at least 0.5. The predetermined free mass value may be, for example, 0.95 i.e. a probability of being free of 95%, although it will be appreciated that other values may be unseen. As can be appreciated, as a result of an increased certainty of [symbol] usually being empty i.e. being within the FOV 605, 650 of the sensor 160, 170 and other cells corresponding to the detection of object(s) i.e. cells 640, 645 such that it can be reliably inferred that the sensor is operational, there can be increased confidence that the visible and empty cells 690 do not correspond to objects and thus a value associated with said cells can be controlled to be indicative of the increased confidence, such as a predetermined free mass value of equal to or greater than 0.7, or equal to or greater than 0.8, 0.9 or 0.95. As such, when the free mass value is combined with the prior free mass value for the cell the cell is denoted more quickly as being empty.

In block 560, for obscured cells the unknown mass or probability may be set to a predetermined value, such as 0.5 although other values may be chosen. In some embodiments the unknown mass value may be between 0.4 and 0.6. The unknown mass of 0.5 equates to a 50:50 likelihood of being occupied and unoccupied. In some embodiments, the occupied_mass value and the free_mass values may be set to predetermined values, such as indicative of the 50:50 likelihood. For example, the occupied_mass value may be set to 0.5 and the free_mass value set to 0.5. However in other embodiments, both values may be set to 0 to be indicative of an unknown mass of 1. It will be appreciated that other values may be chosen to have a similar or equivalent effect. For example, the free mass value and the occupied mass value may each be updated to be less than 0.3.

Because the Dempster-Schafer rule of combination is used to combine the unknown mass or BBA, as discussed below, with the prior mass, the occupied mass gradually, i.e. over a number of iterations or updates, moves from what was previously measured to be a value indicative of unknown occupancy. Therefore, if a detection was previously seen in a now occluded or obscured cell, such as one of cells 680 in FIG. 6, the occupancy mass of that cell will not immediately change to be indicative of unknown occupancy. It takes several cycles of the cell being occluded to degrade the occupied mass such that it is indicative of being of unknown occupancy. The same is true in reverse; if a cell that was previously visible and empty is now occluded, a number of iterations or cycles are required for the cell to be indicative of unknown occupancy. The amount of time or the number of iterations it takes for this to occur may be controlled in some embodiments by a parameter fov_threshold which controls what is considered an opaque cell by the algorithm, i.e. what occupancy mass of a cell we consider as occupied by a detection. For example, if fov_threshold is set to 0.4, then any cells having an occupied_mass equal to or above the fov_threshold value of 0.4 are considered to be occupied.

In block 470 the mass values determined as a result of the FOV of the sensor are combined with those of the measurement grid map.

Combining the FoV with the measurement grid map may be performed with the Dempster-Schafer (DS) rule of combination. FIG. 7 illustrates occupied and free masses of two cells 710, 720 which are to be combined using the DS rule of combination as below.

The first cell 710 has an occupied mass equal to 0.2 (p(o1)=0.2), a free mass equal to 0.3 (p(f1)=0.3) and unknown equal to 0.5. The second cell 720 has p(o2)=0.5, p(f2)=0.25 and unknown equal to 0.25.

According to the DS formula, K is equal to the sum of the product of all the combinations of disjoint sets. In this example, for simplicity of explanation, this means Occupied vs Free. These two possibilities are incompatible, so they can be considered “disjoint sets”. This translates to:

$$K = p ( o 1 ) ⋆ p ( f 2 ) + p ( o 2 ) ⋆ p ( f 1 ) = 0.2 ⋆ 0.25 + 0.5 ⋆ 0.3 = 0.2$$

$${K}^{′} = 1 / ( 1 - K ) = 1.25$$

The uncertainty is calculated intuitively as:

$$p ( u 1 ) = 1 - p ( o 1 ) - p ( f 1 ) = 0.5$$

$$p ( u2 ) = 1 - p ( o 2 ) - p ( f 2 ) = 0.25$$

The numerator is the sum of the product of all combinations of sets which intersect:

$$\begin{matrix}p ( o 3 ) = {K}^{′} ( p ( o 1 ) ⋆ p ( o 2 ) + p ( o 1 ) ⋆ p ( u 2 ) + p ( o 2 ) ⋆ p ( u 1 ) ) \\ = 1.25 ⋆ ( 0.2 ⋆ 0.5 + 0.2 ⋆ 0.25 + 0.5 ⋆ 0.5 ) \\ = 1.25 ⋆ 0.4 = 0.5\end{matrix}$$

$$\begin{matrix}p ( f 3 ) = {K}^{′} ( p ( f 1 ) ⋆ p ( f 2 ) + p ( f 1 ) ⋆ p ( u 2 ) + p ( f 2 ) ⋆ p ( u 1 ) ) \\ = 1.25 ⋆ ( 0.3 ⋆ 0.25 + 0.3 ⋆ 0.25 + 0.25 ⋆ 0.5 ) \\ = 1.25 ⋆ 0.275 = 0.34375\end{matrix}$$

$$p ( u 3 ) = 1 - p ( o 3 ) - p ( f 3 ) = 0.15625$$

In some embodiments, particle association is performed with the detections in block 460. This allows the DOGMa process to create and maintain particles associated with detections. Advantageously computational effort is not wasted on associated particles that model nothing in the real-world.

Returning to FIG. 4, in block 460 of the method 400 one or more particles are associated with the measurement grid map. In some embodiments, a data structure particle_association_info is associated with the measurement grid map. This data structure stores a probability for each cell for particles in that cell being associated with a measurement of an object. In some embodiments, the probability y is determined with a probability density function according to a Normal Gaussian distribution, although it will be appreciated that other distributions may be used. The function may be:

$$y = \frac{1}{s \sqrt{( 2 π )}} exp ( - 0.5 \frac{{( x - m )}^{2}}{{s}^{2}} )$$

Where y is indicative of the probability of a cell, and therefore any particles within the cell, being associated with a measurement of an object, mean (m) may be 0, sigma(s) may be 1 and x is the distance in meters from the cell to the detection of the object. Thus, for particles in each cell, the probability y of the particles being associated with a detection is determined in block 460.

In block 470 one or more components of particles are determined. The particles for which the one or more components are determined in block 470 may be newly born particles and persistent particles in the posterior belief i.e. posterior BBA.

In some embodiments, the one or more components, which may be represented as occupied_mass_components are determined using the occupied_mass from the determined measurement grid map, the prior_occupied_mass from DOGMa Grid as determined in the prediction of block 410 and a birth_probability parameter. The occupied_mass_components represents the components of newly born particles, which are used in resampled block 480 below, and the components of persistent particles which are used in update block 475 below. The birth_factor parameter controls a balance of newly created particles versus persistent particles. The birth_factor parameter may assume a value in a predetermined range such as 0-1. The higher the value the less likely particles are to persist between time steps, thereby controlling how sensitive the method 400 is to incoming detections. A value of 0 means no new particles are created, whereas a value of 1 means that particles will be created directly relative to the occupied mass. A greater number of new particles being created results in a greater number of existing particles being pruned in the resample block 480. As an example, the birth probability may be around 0.02, although other values may be chosen. The function below returns a set of persistent particles (pers_mass) to use in the update block 475 below, and a set of particles to be created to use in the resample block 480 (born_mass).

$$scaled\_free \_plausibiity = birth\_factor ⋆ ( 1 - prior\_occupied \_mass )$$

$$born\_mass = \frac{( occupied\_mass \cdot scaled\_free \_plausibility )}{( prior\_occupied \_mass + scaled\_free \_plausability )}$$

Please note occupied_mass and scaled_free_plausibility are vectors multiplied with Schur product. The scaled_free_plausability variable has a purpose of reducing a probability of particles being born. Where pers_mass may be calculated as:

$$pers\_mass = occupied\_mass - born\_mass$$

The persistent mass pers_mass is a remainder of the born mass being deducted from the occupied mass. Please note that the operations above are element wise vector operations.

Block 470 is an update block. In block 475, cells and particles in the dynamic occupancy grid map are updated or modified with the detections incorporated into the measurement grip map, which also includes the effect of the FOV determination according to an embodiment of the invention discussed above with reference to FIG. 5 in particular.

For use in the particle update a function likelihood may be defined that calculates the Doppler measurement likelihood according to the method from DOGMa Thesis (Nuss, 2017) (equation 5.70 and 5.71 pp. 77). In essence, the update operation in block 475 is a determination of the likelihood of a particle existing relative to an incoming measurement. i.e. if a particle is close to the measurement, and has a similar velocity, then the particle will be given a greater weight.

Block 475 may comprise cell occupancy and particle updating processes. The cell occupancy is updated in block 475 by updating the posterior BBA with the BBA from the measurement grid map and the prior BBA. As described above, the updating may be performed using the Dempster-Schafer Rule of Combination for the occupied and free masses.

In block 475 particle weights are updated. A function to update particle weights is used in some embodiments which carries out a vector multiplication between existing, un-normalised, weights of the particles and the Doppler measurement likelihood that is referred to above. Updating particles in this way degrades the particle weights depending on how much their states differ from the incoming detection.

A normalisation factor may be used in some embodiments for each cell to normalise the weights of particles that are within each cell. Such normalisation is done separately for associated (associated with a detection) and un-associated cells. With associated cells, the persistence mass for a cell may be divided by the sum of the particle weight in that cell. Persistence mass is relative to the incoming detections in the measurement grid map, where the persistence mass is calculated in block 470 above. This is carried out for every cell in the measurement grid map. In effect, this process increases particle weights for particles that are at, or close to, incoming detections from the one or more sensors 160, 170. Un-associated cells may be updated by dividing the persistence mass by the prior occupied mass. The un-associated and associated weight normalisation factors are updated in this way. These are vectors with entries for each cell.

In some embodiments, normalisation may be carried out on the weights vector. The normalisation may use the unnormalised_weights for each particle, associated_particles_normalisation_factors for each cell, unassociated_particles_normalisation_factors for each cell and the association_prob from the measurement grid map. This step of block 475 determines a probability for each cell for particles in the cell to be associated with a measurement. Each particle has a probability of being associated and of being un-associated, which in added together may form the weight of the particle in some embodiments.

An association part may be calculated by the association probability of the cell multiplied by the associated particles normalisation factor and the un-normalised weight of the particle.

$$associated\_part = association\_prob ⋆ associated\_particles \_normalisation \_factors ( cell ) ⋆ unnormalised\_weights ( particle ) ;$$

An un-associated part is calculated as:

$$unassociated\_part = ( 1 - associated\_ particles \_normalisation \_factors ( cell ) ⋆ weights ( particle ) ;$$

The above process may be carried out for every particle.

In block 480 a resampling operation is performed. During the resampling operation, new particles are initialised, which may be according to the born mass discussed above, and other existing particles are pruned. As mentioned above, pruning may performed to maintain the total number of particles in the dynamic grid map at a defined num_particles parameter which provides a desired number of particles for the grid map. After new particles are both the number of particles is num_particles+number_of_birth_particles where number_of_birth_particles defines the number of born particles. Pruning is used to reduce the number of particles to num_particles. In some embodiments, the pruning may comprise generating a number of uniformly distributed random numbers. The distribution of random numbers will be of size num_particles to index particles in the total number of particles. These are the particles that will persist, with the rest being pruned, thereby maintaining the number of particles at num_particles.

In some embodiments, a sampler function is used. The sampler function is a function to assist in performing weighted random sampling. Use of the function is modular in that a different sampler functions can be used in block 480. In one embodiment a discrete distribution is used which returns random numbers where the probability of integer/is defined as:

$$I = \frac{{w}_{i}}{S}$$

Where wᵢ is the weight of the i-th integer divided by the sum S of all n weights where n is the number of weights. It may be considered that the random sampler has a greater likelihood of retaining particles having a higher weight.

New particles may be created during the resampling operation in block 480. In some embodiments, the creating of particles may be controlled by parameters new_particles_per_cell: the number of new particles that should be created in each cell, proportional to the born_mass.

born_mass: for each cell, the component of the posterior occupied mass for new particles. probability_for_cell: This contains the probability for each cell for particles in that cell to be associated with a measurement. max_velocity: Maximum velocity to be used for newly initialised particles in meters per second.

A particle creation function in some embodiments is used which returns a pair where the ‘first’ member is a Nx4 matrix, where N is the total number of new particles, of particles states as [x y vx vy], and a′second′ member is a Nx1 vector of particle weights.

New particles may be instantiated in a cell where the higher the born_mass the larger number of particles will be created. Since born_mass is relative to incoming detections, this results in more particles created around incoming detections.

These particles are created with a position and velocity strategy. The strategy may comprise instantiating particles with a distribution, such as a standard random distribution, inside a cell. Advantageously particles are not all created at the centre of a grid cell, but distributed randomly around the cell with random velocities. In some embodiments, all new particles are un-associated, so they are instantiated with a label ID that represents un-associated, such as −1 although other labels may be used.

The creation of new particles may provide a vector of new particles. New particles may be appended to existing particles. In some embodiments, the created joint vector of particles is resampled, such as using the sampler function noted above. In this way, new particles are created for the particle filter and, at the same time, low-weight particles are pruned so that the total number of particles is maintained at the defined limit.

In block 490, labels associated with particles are updated to represent objects. The particles may be clustered using a DBSCAN algorithm (Ester, et al., 1996), although other methods of clustering particles may be used. The clustering creates clusters of particles with the same label which will be extracted to an untracked object with a centre point, velocity and bounding box. This algorithm will associated groups of particles as an object. A configurable min_points determines the minimum number of particles that need to be in a cluster for it to be considered an object and an epsilon variable to configure the distance allowable between particles to be considered part of the cluster.

This object extraction allows the dynamic occupancy grip to produce untracked objects which are then output to an Object Level Tracker (OLT) as another sensor input to be fused with data from other sensors, such as camera and radar sensors. Since these objects are fairly simple, e.g. they lack any classification detail, they can be fused with data from sensors that allows high quality classification to be provided, such as camera/Lidar, and to improve the position and velocity estimates of those sensors.

In some embodiments, a conversion is performed from the BBA to a value representing a probability of occupancy. Advantageously, this conversion assists in using the occupancy grid map. The value representing the probability may be an integer such as in the range 0-1, rather than the BBA of two different possibilities (occupied and free). Therefore, in some embodiments, the BBA is converted into a probability value for each cell to be occupied.

The conversion may be performed by:

$$probability = cell\_occupied + 0.5 ⋆ ( 1 - cell\_ occupied - cell\_free )$$

In block 495 the occupancy grid map is output. The occupancy grid map contains a probability of occupancy for each cell in the occupancy grid map, and an associated list of detected objects which are extracted from the occupancy grip map, as described above. In block 495 the controller 110 outputs occupancy grid map data 155 indicative of the occupancy grip map 300 and the objects.

The occupancy grid map data 155 may be provided to another controller of the vehicle 200, for controlling movement of the vehicle 200. The occupancy grid map data 155 may be used to determine a path of the vehicle 200. The occupancy grid map data 155 may be used reduce a likelihood of the vehicle 200 coming into contact with any objects in the environment of the vehicle 200.

The objects may be used as input to an Object Level Tracker (OLT) that performs association, tracking and state estimation on tracks from multiple sensors. The OLT may perform association using a Munkres algorithm (Konstantinova, et al., 2003). The tracker maintains a list of tracks that are updated with the output of the association. Finally, state estimation may handled with the reuse of the particle filter described above or use of an Unscented Kalman Filter (UKF). A paired down version with a much smaller amount of particles is used to model the state of each track. This is done by removing the grid, instead the world that is modelled by the particle filter is the bounding box of the [symbol] by any incoming detection that the Association step has determined is related to this track.

It will be appreciated that various changes and modifications can be made to the present invention without departing from the scope of the present application.

1. A control system for a vehicle, the control system comprising at least one controller, the control system being configured to:
receive, from at least one sensor, sensor data indicative of a location of one or more objects detected in an environment of the vehicle; and
modify an occupancy grid stored in a memory accessible to the control system in dependence on the sensor data, the occupancy grid representing an environment of the vehicle and having a plurality of cells, wherein each cell is associated with at least one value indicative of a likelihood of a corresponding portion of the environment being occupied by one of the one or more objects,
wherein the modifying comprises the control system being configured to:
determine one or more cells of the occupancy grid where a field of view of the at least one sensor is obstructed by at least one of the one or more objects; and
modify the at least one value associated with the determined one or more cells of the occupancy grid to be indicative of an increased uncertainty of the cell being occupied by an object.

2. The control system of claim 1, wherein the at least one value associated with the determined one or more cells of the occupancy grid is an unknown mass value, and the control system is arranged to modify the unknown mass value to a value indicative of the increased uncertainty of the cell being occupied by the object, and optionally, wherein the unknown mass value is given a value of between 0.4 and 0.6

3. The control system of claim 1, wherein the at least one value associated with the determined one or more cells of the occupancy grid is a free mass value and an occupied mass value, and the control system is arranged to modify the free mass value and the occupied mass value to respective values indicative of the increased uncertainty of the cell being occupied by the object, and optionally, wherein the free mass value and the occupied mass are each:
given a value between 0.4 and 0.6;
given a value less than 0.3; or
given a value of substantially 0.

4. The control system of claim 1, wherein the modifying comprises the control system being configured to:
determine one or more cells of the occupancy grid within the field of view of the sensor for which the sensor data did not indicate the location of an object; and
modify the at least one value associated with the determined one or more cells of the occupancy grid to be indicative of an increased likelihood of the cell being unoccupied by an object.

5. The control system of claim 1, wherein the at least one value associated with the one or more cells of the occupancy grid for which the sensor data did not indicate the location of an object is a free mass value, and the control system is arranged to modify the free mass value to a value indicative of a likelihood of the cell being unoccupied by the object.

6. The control system of claim 2, wherein the modifying comprises the control system combining a predetermined unknown mass value with a prior unknown mass for the one or more cells of the occupancy grid within the field of view of the sensor where the field of view of the sensor is obstructed by at least one of the one or more objects, and optionally, wherein the combining is according to a Dempster Shafer rule of combination.

7. The control system of claim 1, wherein the modifying comprises the control system being configured to:
determine the field of view of the sensor in dependence on one or more characteristics associated with the sensor; and
select the one or more cells of the occupancy grid corresponding to the field of view of the sensor.

8. The control system of claim 1, wherein the modifying comprises the control system being configured to:
determine a first field of view of the sensor;
determine one or more cells of the occupancy grid within the first field of view of the sensor;
determine a cell of the occupancy grid corresponding to a location of one of the one or more objects detected in the environment of the vehicle within the first field of view of the sensor; and
determine a second field of view of the sensor in dependence on one or more characteristics associated with the sensor and the location of the one of the one or more objects.

9. The control system of claim 1, wherein the control system is configured to:
determine the one or more cells of the occupancy grid where the field of view of the sensor is obstructed by at least one of the one or more objects as cells in a shadow of the one of the one or more objects detected in the environment of the vehicle.

10. The control system of claim 1, the control system being configured to sequentially select cells of the occupancy grid outward from a location of the sensor to determine whether the sensor data indicates the location of an object.

11. The control system of claim 1, wherein the control system is arranged to divide the environment of the vehicle into a plurality of regions around the vehicle, and to separately update the occupancy grid for each of the plurality of regions.

12. A system for a vehicle, comprising:
the control system of claim 1; and
at least one sensor arranged to output sensor data indicative of a location of one or more objects detected in an environment of the vehicle.

13. A vehicle comprising the control system according to claim 1.

14. A computer-implemented method, comprising:
receiving, from at least one sensor, sensor data indicative of a location of one or more objects detected in an environment of a vehicle; and
modify an occupancy grid stored in a memory in dependence on the sensor data, the occupancy grid representing an environment of the vehicle and having a plurality of cells, wherein each cell is associated with at least one value indicative of a likelihood of a corresponding portion of the environment being occupied by one of the one or more objects,
wherein the modifying comprises the control system being configured to:
determine one or more cells of the occupancy grid where a field of view of the at least one sensor is obstructed by at least one of the one or more objects; and
modify the at least one value associated with the determined one or more cells of the occupancy grid to be indicative of an increased uncertainty of the cell being occupied by an object.

15. Computer software which, when executed by a computer, is arranged to perform a method according to claim 14; optionally the computer software is tangibly stored on a non-transitory computer readable storage medium.

16. A vehicle comprising the system according to claim 12.
